(19) United States
(12) Patent Application Publication
(10) Pub. No.: US 2007/0297754 A1
(43) Pub. Date: Dec. 27, 2007

(54) Receiving apparatus and method of controlling a receiving apparatus

(76) Inventor: Naoyuki Wada, Fuchu-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/801,492

(22) Filed: May 9, 2007

(30) Foreign Application Priority Data
May 18, 2006 (JP) 2006-139310

(51) Int. Cl. H04N 5/91

(52) U.S. Cl. 386/46

(57) ABSTRACT

According to one embodiment, a receiving apparatus includes a receiving unit configured to receive digital television broadcast data, a first reproducing unit configured to select data for first content from the digital television broadcast data received by the receiving unit and to reproduce the selected data, a second reproducing unit configured to select data for second content from the digital television broadcast data received by the receiving unit and to reproducing the selected data, and a switching unit configured to selectively operating either the first reproducing unit or the second reproducing unit.

### CROSS-REFERENCE TO RELATED APPLICATIONS

This application is based upon and claims the benefit of priority from Japanese Patent Application No. 2006-139310, filed May 18, 2006, the entire contents of which are incorporated herein by reference.

### BACKGROUND

1. Field

One embodiment of the invention relates to control techniques suitable for, for example, a notebook personal computer which has a TV function of viewing digital television broadcasts and can be powered by a battery.

2. Description of the Related Art

In recent years, an information processing apparatus which can be powered by a battery and is easy to carry, such as a notebook personal computer, has become increasingly sophisticated. A portable information processing apparatus capable of receiving digital television broadcast data has recently begun to be popularized, which enables viewers to enjoy television broadcasts even while moving or in a place where they have gone.

In the case of a portable information processing apparatus, its use environment can change significantly at different times. Moreover, the reception condition of digital television broadcast data is not constant. Therefore, several methods of dealing with changes in the environment in the middle of receiving digital television broadcast data have been proposed (e.g., refer to Jpn. Pat. Appln. KOKAI Publication No. 2006-13708).

In the digital signal receiving apparatus in Jpn. Pat. Appln. KOKAI Publication No. 2006-13708, when the reception intensity of the content being received has dropped below a specific value, another content which has a high coincidence with the content is selected. For example, in the case of a sports program, even if channels (or deliverers) differ, the continuity can be secured in terms of contents.

Recently, the delivery of digital television broadcast data known as one-segment broadcasting has been started for mobile phones and PDA terminals and has attracted increasing attention. Data for one-segment broadcasting is obtained by degrading the picture quality of ordinary (HD: High Definition) digital television broadcast data, and modulating the data by a modulation method immune to noise. The resulting data, together with ordinary digital television broadcast data, is carried using the same frequency band. As compared with ordinary digital television broadcast data using 12 segments, one-segment broadcast data enables the amount of data processed in, for example, a decoding operation necessary for viewing to be reduced remarkably (although the picture quality is degraded).

Accordingly, under a situation where electric power saving is considered to be more important than picture quality and viewing should be allowed to last as long as possible at the time of, for example, the occurrence of a disaster, it is desirable to prepare a mechanism for switching a high-performance notebook computer capable of receiving and viewing ordinary digital television broadcast data to the mode of low-picture-quality one-segment broadcasting.

So far, however, attention has been directed to how to enable people to continue receiving and viewing agreeable images and therefore the above-described idea hasn't been got.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an exemplary system configuration of an information processing apparatus according to an embodiment of the invention;

FIG. 2 is an exemplary block diagram of a TV tuner unit included in the information processing apparatus;

FIG. 3 shows an exemplary frequency band used in carrying digital television broadcast data received by the TV tuner unit of FIG. 2;

FIG. 4 shows an exemplary setting screen displayed by a TV application program running on the information processing apparatus of FIG. 1; and

FIG. 5 is an exemplary flowchart showing the sequence of the operation of automatically switching from HD content to one-segment content executed by the information processing apparatus of FIG. 1.

### DETAILED DESCRIPTION

Various embodiments according to the invention will be described hereinafter with reference to the accompanying drawings. In general, according to one embodiment of the invention, a receiving apparatus includes a receiving unit configured to receive digital television broadcast data, a first reproducing unit configured to select data for first content from the digital television broadcast data received by the receiving unit and to reproduce the selected data, a second reproducing unit configured to select data for second content from the digital television broadcast data received by the receiving unit and to reproducing the selected data, and a switching unit configured to selectively operating either the first reproducing unit or the second reproducing unit.

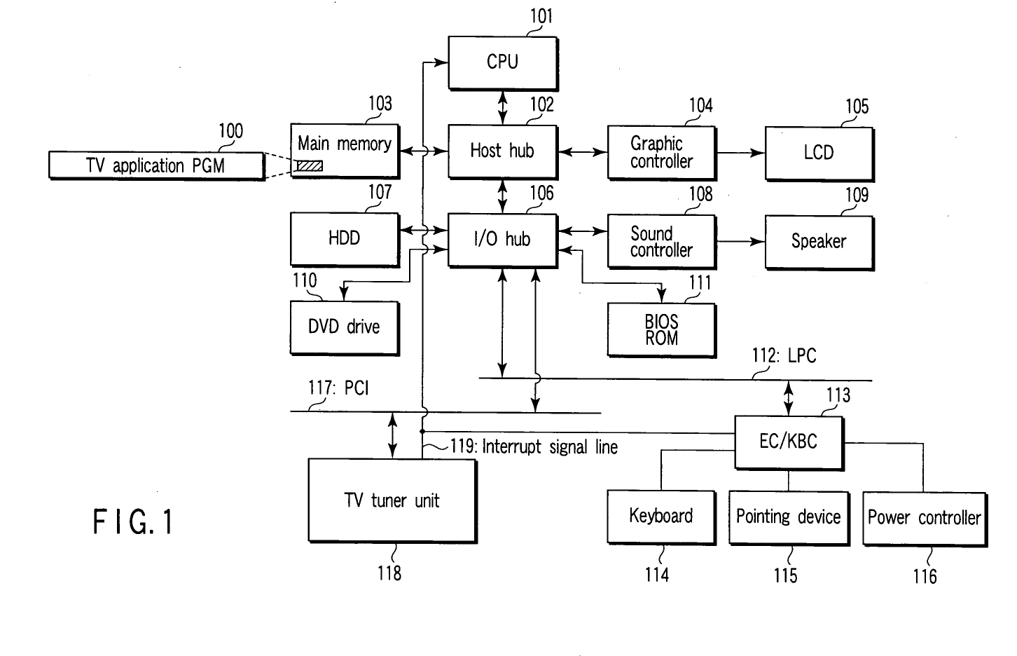

A receiving apparatus of the invention has been realized using an information processing apparatus, such as a notebook personal computer. FIG. 1 shows an exemplary system configuration of an information processing apparatus according to the invention.

As shown in FIG. 1, the information processing apparatus of the embodiment comprises a CPU 101, a host hub 102, a main memory 103, a graphic controller 104, an LCE 105, an I/O hub 106, a hard disk drive (HDD) 107, a sound controller 108, a speaker 109, a DVD drive 110, a BIOS-ROM 111, an LPC bus 112, an embedded controller/keyboard controller (EC/KBC) 113, a keyboard 114, a pointing device 115, a power controller 116, a PCI bus 117, a TV tuner unit 118, and an interrupt signal line 119.

The CPU 101 is a main processor which controls the operation of the information processing apparatus. The CPU 101 executes an operating system and various programs including utilities loaded from the HDD 107 into the main memory 103. One of the programs is a TV application program 100 explained later.

The host hub 102 is a bridge device which connects a local bus of the CPU 101 and the I/O hub 106. The host hub 102 includes a memory controller for controlling the main memory 103. To the host hub 102, the graphic controller 104 for driving the LCD 105 is connected.

The I/O hub 106 functions as an I/O controller for controlling various I/O devices connected to the LPC bus 112 and PCI bus 117. The I/O hub 106 includes an IDE for controlling the HDD 107. The access of the sound controller 108 for driving the speaker 109, DVD drive 110 and BIOS-ROM 111 is also controlled by the I/O hub 106. The BIOS-ROM 111 is a flash ROM which stores a BIOS in such a manner that the BIOS can be rewritten electrically.

The EC/KBC 113 is a one-chip microcomputer into which an embedded controller which communicates with the power controller 116 that manages power supply to each section of the information processing apparatus and a keyboard controller which controls the keyboard 114 and pointing device 115 are integrated. The information processing apparatus can be operated by a battery or an external power supply. The power controller 116 informs the EC/KBC 113 of power information, including the presence or absence of the power supply from an external power source and the remaining amount of battery power.

The TV tuner unit 118 receives digital television broadcast data, demodulates or decodes the data, and outputs the resulting data to the PCI bus 117. The TV application program 100 adopts or rejects the digital television broadcast data output by the TV tuner unit 118 to the PCI bus 117. The image of the selected content is output via the graphic controller 104 to the LCD 105. The sound of the selected content is output via the sound controller 108 to the speaker 109. In recording, the video data and audio data are output to the HDD 107 or DVD drive 110.

To the TV tuner unit 118 and EC/KBC 13, the interrupt signal line 119 for supplying an interrupt signal to the CPU 101 is connected.

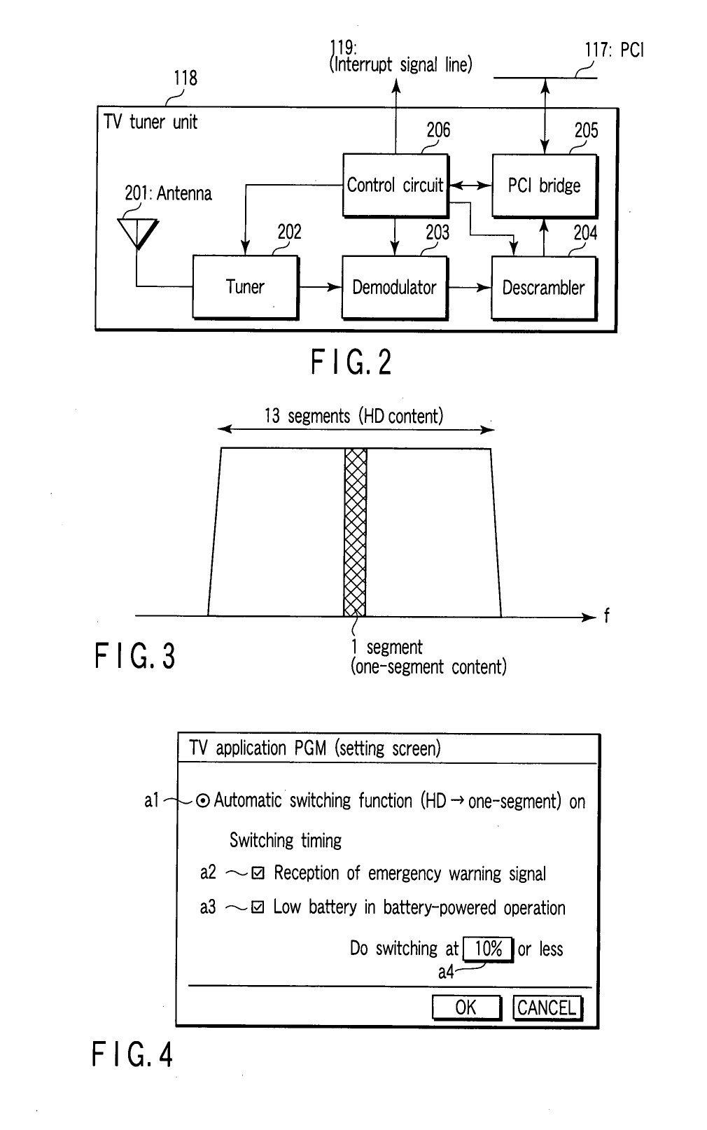

FIG. 2 is an exemplary block diagram of the TV tuner unit 118. The signal input from an antenna 201 is converted into an IF frequency by a tuner 202. Then, an AGC (Automatic Gain Control) circuit included in the tuner 202 outputs the resulting signal at a constant level. A demodulator 203 converts an analog input signal into a digital signal, thereby detecting an error and correcting the error. The demodulator 203 outputs digital data in a normal 0 and 1 representation.

A descrambler 204 has the function of descrambling the digital data on the basis of the flag in the input data. In ISDB-T, the video data and audio data in ordinary digital television broadcasting are scrambled, whereas program information and one-segment broadcasts are not scrambled.

A PCI bridge 205, which has a PCI interface, outputs data to the PCI bus 117. A control circuit 206 is a circuit which controls the operation of the TV tuner unit 118. The control circuit 206 has the function of supplying an interrupt signal via the interrupt signal line 119 to the CPU 101 when there is an emergency warning signal in the data digitally converted by the demodulator 203. When being operated by the battery without an external power source, the EC/KBC 113, if the remaining amount of the battery power has dropped to a preset value or below, supplies an interrupt signal via the interrupt signal line 119 to the CPU 101.

FIG. 3 shows an exemplary frequency band used in carrying digital television broadcast data received by the TV tuner unit 118. As shown in FIG. 3, the digital television broadcast data received by the TV tuner unit 118 is carried using a frequency band corresponding to 13 segments. Of the 13 segments, 12 segments are allocated to normal content (HD content) and the remaining one is allocated to one-segment broadcast content (or one-segment content). On the basis of identification data called PID, only the desired content data can be selected and obtained from the digital television broadcast data in which a plurality of contents are mixed.

Although HD content and one-segment content are the same content, HD content has a resolution of 1920×1080 pixels, whereas one-segment content has as low a resolution as 352×240 pixels. However, having only a low resolution, one-segment content causes the amount of data processed in, for example, decoding to be reduced remarkably as compared with HD content. That is, power saving is achieved. Focusing on this point, the information processing apparatus of the embodiment provides a mechanism for switching from HD content to one-segment content automatically under a specific situation, such as the occurrence of a disaster or a low-battery state. This will be explained in detail below.

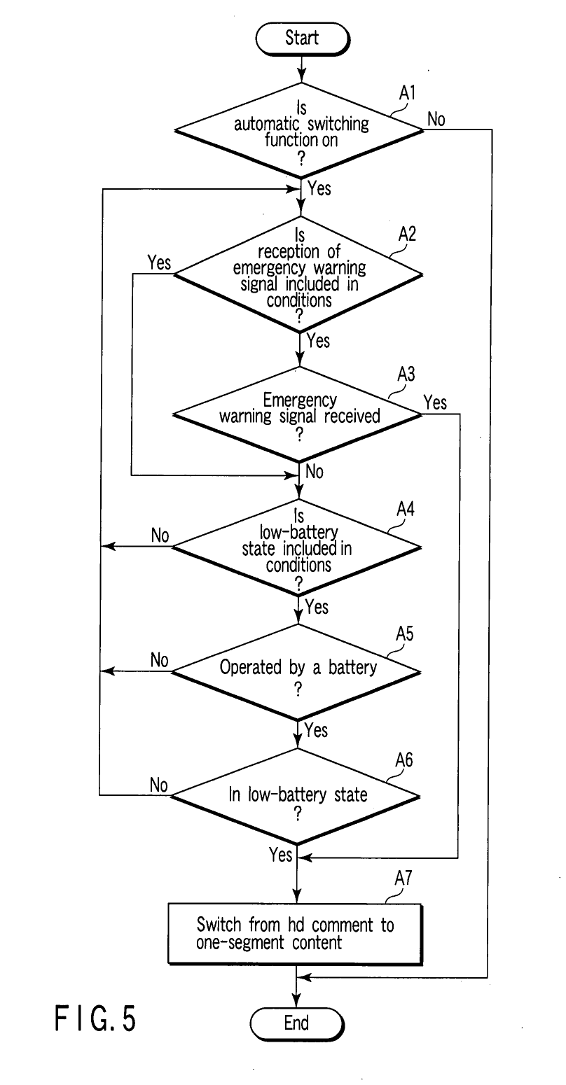

FIG. 4 shows an exemplary setting screen displayed by the TV application program 100.

On the setting screen displayed by the TV application program 100, there is provided a button a1 for setting whether to enable the function of switching from HD content to one-segment content automatically. To enable the function, the button a1 is turned on. Further on the setting screen, there are provided check boxes a2, a3 for setting with what timing HD content is switched to one-segment content.

With the check box a2 being checked, when digital television broadcast data including an emergency warning signal is received by the TV tuner 118 and the control circuit 206 of the TV tuner unit 118 supplies an interrupt signal to the CPU 101, HD content is switched to one-segment content under the control of the TV application program 100. With the check box a3 being checked, when the remaining amount of the battery power in a battery-powered operation has dropped to a setting value or below and the EC/KBC 113 has supplied an interrupt signal to the CPU 101, HD content is switched to one-segment content under the control of the TV application program 100. An input field a4 is provided to allow the user to set the remaining amount of the battery power arbitrarily as a reference value. The remaining amount of the battery power set here is transferred from the TV application program 100 to the EC/KBC 113. The EC/KBC 113 holds the remaining amount of the battery power.

Both of the check boxes a2 and a3 can be checked at the same time. In FIG. 4, the function of switching from HD content to one-segment content automatically is enabled, which causes the automatic switching function to operate when an emergency warning signal is received or when the battery is low (in a battery-powered operation).

When switching from HD content to one-segment content, the TV application program 100 instructs the control circuit 206 of the TV tuner unit 118 to stop the descrambler 204. As described above, since one-segment broadcasts have not been scrambled, the operation of the descrambler 204 is useless. That is, this is control for saving power as much as possible. To accomplish the same purpose, the TV application program 100, when switching from HD content to one-segment content, reduces the processing speed of the CPU 101, taking a substantial reduction in the amount of processed data into account, and dims or turns off the backlight of the LCD 105.

FIG. 5 is an exemplary flowchart showing the sequence of the operation of automatically switching from HD content to one-segment content executed by the information processing apparatus of the embodiment.

When the function of switching from HD content to one-segment content automatically has been set active (YES in block A1), the TV application program 100 determines whether the reception of an emergency warning signal has been set as conditions for the automatic switching (block A2). If the reception has been set (YES in block A2), the TV application program 100 switches from HD content to one-segment content automatically (block A7) with the timing with which the TV tuner unit 118 supplies an interrupt signal indicating the reception of an emergency warning signal (YES in block A3).

Furthermore, the TV application program 100 determines whether the low-battery state has been set as conditions for the automatic switching (block A4). If it has been set (YES in block A4), the TV application program 100 switches from HD content to one-segment content automatically (block A7) with the timing with which the EC/KBC 113 supplies an interrupt signal indicating that the apparatus is being operated by the battery and is in the low-battery state (YES in block A5 and YES in block A6).

As described above, although being capable of viewing HD content, the information processing apparatus of the embodiment, when being placed under specific conditions, dares to switch from HD content to low-picture-quality one-segment content, thereby achieving power saving, which realizes the continuation of viewing as long as possible.

While in the embodiment, HD content has been switched to one-segment content with the timing with which the low-battery state has been reached in a battery-powered operation, the switching may be done at the time when the power supplier is changed from the external power supply to the battery. Also the emergency warning signal has been extracted from digital television broadcast data. Moreover, any one of the existing methods of obtaining the signal may be applied to the apparatus.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the method and systems described herein may be made without departing from the spirit of the inventions. The accompanying claims and their equivalents are intended to cover such forms or modifications as would fall within the scope and spirit of the inventions.

What is claimed is:

1. A receiving apparatus comprising:
a receiving unit configured to receive digital television broadcast data;
a first reproducing unit configured to select data for first content from the digital television broadcast data received by the receiving unit and to reproduce the selected data;
a second reproducing unit configured to select data for second content from the digital television broadcast data received by the receiving unit and to reproducing the selected data; and
a switching unit configured to selectively operating either the first reproducing unit or the second reproducing unit.

2. The receiving apparatus according to claim 1, wherein the receiving unit receives digital television broadcast data carried using a frequency band for N+1 segments,
the first reproducing unit selects N segments of data from the digital television broadcast data and reproduces the first content, and
the second reproducing unit selects one segment of data from the digital television broadcast data and reproduces the second content which has the same substance as that of the first content and is lower in picture quality than the first content.

3. The receiving apparatus according to claim 1, wherein the switching unit switches from the first reproducing unit to the second reproducing unit when an emergency warning signal has been added to the digital television broadcast data received by the receiving unit.

4. The receiving apparatus according to claim 1, wherein the switching unit switches from the first reproducing unit to the second reproducing unit when an external power supply is stopped.

5. The receiving apparatus according to claim 1, further comprising a battery,
wherein the switching unit switches from the first reproducing unit to the second reproducing unit when the remaining amount of power of the battery has been lower than a predetermined value.

6. The receiving apparatus according to claim 3, further comprises setting unit configured to set whether to cause the switching unit to switch from the first reproducing unit to the second reproducing unit.

7. The receiving apparatus according to claim 1, further comprising:
a CPU; and
a control unit configured to reduce the processing speed of the CPU when the switching unit has switched from the first reproducing unit to the second reproducing unit.

8. The receiving apparatus according to claim 1, further comprising:
a display unit which displays the first content or the second content; and
a control unit configured to lower the luminance of the display unit when the switching unit has switched from the first reproducing unit to the second reproducing unit.

9. The receiving apparatus according to claim 1, further comprising:
a decoding unit configured to decode the digital television broadcast data; and
a control unit configured to stop the decoding unit when the switching unit has switched from the first reproducing unit to the second reproducing unit.

10. A method of controlling a receiving apparatus, comprising:
receiving digital television broadcast data;
operating a first reproducing process for selecting data for first content from the received digital television broadcast data and reproducing the selected data; and
switching, when a predetermined situation has been reached, from the first reproducing process to a second reproducing process for selecting data for second content from the received digital television broadcast data and reproducing the selected data.

11. The method of controlling a receiving apparatus according to claim 10, wherein the switching switches from the first reproducing process to the second reproducing process when an emergency warning signal has been added to the digital television broadcast data.

12. The method of controlling a receiving apparatus according to claim 10, wherein the switching switches from the first reproducing process to the second reproducing process when an external power supply is stopped.

13. The method of controlling a receiving apparatus according to claim 10, wherein the switching switches from the first reproducing process to the second reproducing process when the remaining amount of power of a battery provided in the receiving apparatus has been lower than a predetermined value.
